(19) United States
(12) Patent Application Publication
(10) Pub. No.: US 2002/0192355 A1
(43) Pub. Date: Dec. 19, 2002

(54) Fibre-enriched table sweeteners

(76) Inventor: Michel Serpelloni, Beuvry-Les-Bethune (FR)

Correspondence Address: HENDERSON & STURM LLP, 1213 MIDLAND BUILDING, 206 SIXTH AVENUE, DES MOINES, IA, 50309-4076, US

(21) Appl. No.: 10/113,142

(22) Filed: Mar. 29, 2002

(30) Foreign Application Priority Data
Mar. 30, 2001 (FR) 01 04414

(51) Int. Cl. A23G 3/00

(52) U.S. Cl. 426/658

(57) ABSTRACT

The subject of the invention is fiber-enriched table sweeteners, characterized in that they comprise from 3 to 99%, and preferably from 10 to 95% by weight of branched maltodextrins having between 15 and 35% of 1→6 glucoside linkages, a reducing sugar content of less than 20%, a polymolecularity index of less than 5 and a number-average molecular mass Mn at most equal to 4500 g/mol, and in that they are stable under acidic conditions. The invention also relates to the method for preparing them.

### FIELD OF THE INVENTION

The subject of the invention is fibre-enriched table sweeteners.

More precisely, the subject of the invention is fibre-enriched powdered table sweeteners containing branched maltodextrins.

### BACKGROUND OF THE INVENTION

The expression “table sweeteners” is usually understood to mean compositions for replacing traditional sugars (sucrose) in powdered form which have a sweetening power comparable with or greater than that of sucrose, for a calorific value of the same order of magnitude (of the order of 4 Kcal/g) or even lower.

Because of their generally higher sweetening power, the quantities of table sweeteners necessary for sweetening foods or drinks are thus smaller than those required with sucrose, which correspondingly reduces the calorie supply for an identical sweetening power.

The sweetening power is, for example, supplied by intense sweeteners prepared by chemical synthesis of the saccharin, aspartame, acesulfame K, cyclamate, stevioside, sucralose, neotame or alitame type.

These table sweeteners also contain with the sweetening agent, bulking agents, usually chosen from polyols such as, for example, sorbitol, xylitol, mannitol, lactitol, maltitol, erythritol and isomalt, taken alone or as a mixture, or alternatively polysaccharides or oligosaccharides such as dextrins, maltodextrins, polydextrose or fructooligosaccharides.

The table sweeteners are intensively used in the food and catering industries, in particular in powdered form, because they provide sweet tastes without a high calorie supply.

Such table sweeteners are thus widespread in so-called dietetic or “light” foods intended for slimming agents or other agents with controlled calorific value.

These table sweeteners are also used in food products intended for diabetics. Accordingly, acesulfame K, which is not metabolized by the body, is commonly used in such compositions.

Table sweeteners are for example the sweeteners marketed under the trademark “CANDEREL”, consisting of the mixture of maltodextrins as bulking agent and aspartame as intense sweetener.

However, these products have a number of disadvantages such as the high intrinsic energy value of the bulking agents (maltodextrins already have a calorific value of 4 Kcal/g), their cariogenicity and the absence of fibre effect.

A partial solution has been proposed by the manufacture, in Japan, of sweeteners under the trademark ELISLIM where the bulking agent is replaced with erythritol, which makes the final product non-cariogenic, but still does not provide any fibre effect.

In addition, the intense sweeteners have a number of drawbacks, such as for example, the lack of stability to pH and to temperature and the pronounced aftertastes above certain concentrations.

It was then proposed to reuse sugars in the form of a mixture with the sweeteners.

The sweet taste is thus provided in part by an intense sweetener and, for the other part, by the sugar or glucose, which maintains an optimum and stable sweet taste over time, whereas the sweetener decomposes under the effect of the acidity and the heat, upon its solubilization.

Table sweeteners have been proposed in EP 1,060,674 where the bulking agent comprises a polydextrose, and the intense sweetener is acesulfame K, aspartame, DL-aminomanoyl-D-alanine isopropyl ester, sodium cyclamate, sodium saccharin, alone or as a mixture.

There have also been proposed, as table sweeteners, compositions containing fructooligosaccharides, as bulking agent, with sucrose.

These fructooligosaccharides exhibit additional functionalities, such as in particular those marketed under the name ACTILIGHT by BEGHIN-SAY or ORAFTI under the name RAFTILOSE.

These table sweeteners, such as ACTISUCRE, based on fructooligosaccharides, thus have, in addition, beneficial effects on health in terms of bifidogenic properties, unlike the compositions mentioned above, i.e. the table sweeteners based on erythritol (such as ELISLIM) or polydextrose.

These fructooligosaccharide-based products have, nevertheless, the disadvantage of being very unstable under acidic pH conditions. This instability results in a gradual hydrolysis in acidic solutions, which generates an undesirable release of glucose and fructose.

In addition, it is known to persons skilled in the art that fructooligosaccharides in high dose are not well tolerated by the human body.

The result of all the preceding text is that there is an unsatisfied need to have table sweeteners which are sources of fibre, which have excellent bifidogenic properties, which are not or scarcely laxative, which are also characterized by their noncariogenicity and their high stability to acids and to heat in aqueous solution.

After long and tedious research studies, the applicant has shown that this need could be satisfied by virtue of using a particular maltodextrin as substitute for the bulking agents.

### DETAILED DESCRIPTION OF THE INVENTION

The subject of the invention is therefore fibre-enriched table sweeteners, characterized in that they comprise from 3 to 99%, and preferably from 10 to 95% by weight of branched maltodextrins having between 15 and 35% of 1→6 glucoside linkages, a reducing sugar content of less than 20%, a polymolecularity index (ratio of weight-average molecular mass over number-average molecular mass) of less than 5 and a number-average molecular mass Mn at most equal to 4500 g/mol, and in that they are stable under acidic conditions.

The expression “branched maltodextrins” is understood to mean, for the purposes of the present invention, the maltodextrins described in Patent Application EP 1,006,128 and in its US counterpart (U.S. Ser. No. 09/455,009) of which the Assignee is proprietor. The entire content of U.S. Ser. No. 09/455,009 is herein incorporated by reference. These branched maltodextrins have an indigestibility character which has the consequence of reducing their calorific value, by preventing their assimilation in the small intestine. They therefore constitute a source of indigestible fibre.

As a guide, their insoluble fibre level is generally greater than 50% on a dry matter basis, a value determined according to the AOAC method No. 985-29 (1986).

By comparison, ACTILIGHT has an insoluble fibre content of less than 2% on a dry matter basis, and polydextrose, of the order of 6% on a dry matter basis.

The low content of molecules with a low degree of polymerization (DP) of the said branched maltodextrins also contributes to their reduced calorific value.

The determination of the calorific value of the branched maltodextrins is carried out by calculation, from the evaluation of the part represented by the fraction which is indigestible in the small intestine and fermented in the large intestine, considered here as supplying 2 Kcal/g. The branched maltodextrins thus have a deduced calorific value of less than 2.5 Kcal/g.

Their high content of 1→6 glucoside linkages has the consequence of reducing their cariogenic power by reducing their assimilation by the microorganisms of the buccal cavity.

This high level of 1→6 linkages also confers on them quite special prebiotic properties: it has indeed appeared that the bacteria of the cæcum and of the colon in humans and animals, such as the butyrogenic, lactic or propionic bacteria, metabolize highly branched compounds.

Moreover, these branched maltodextrins promote the development of bifidogenic bacteria to the detriment of the undesirable bacteria. This results in properties which are quite beneficial to the health of the consumer.

The applicant has found that the incorporation of the said branched maltodextrins therefore advantageously allows partial or complete replacement of the bulking agents in the fibre-enriched table sweeteners in accordance with the invention so as to reduce the cariogenicity thereof, and while constituting a supply of indigestible fibre in an application which the fructooligosaccharides or the polydextroses conventionally used otherwise could not achieve.

Thus, by replacing, for example, in a caloric sweetening composition all or part of the maltodextrins with the branched maltodextrins in accordance with the invention, it is possible to obtain a composition reduced by up to 50% of its initial calorific value, having satisfactory organoleptic qualities.

All the compositions described in Patent Application EP 1,006,128 and in its US counterpart (U.S. Ser. No. 09/455,009 herein incorporated by reference) are appropriate for the preparation of table sweeteners according to the invention.

According to a preferred variant, they have a reducing sugar content of between 2 and 5% and a number-average molecular mass of between 2000 and 3000 g/mol.

According to another advantageous variant, all or some of these branched maltodextrins are hydrogenated.

The fibre-enriched table sweeteners in accordance with the invention may comprise, in addition, an intense sweetener chosen from the group consisting of aspartame, acesulfame K, saccharin, cyclamate, stevioside, sucralose, alone or as a mixture.

Preferably, the said intense sweetener is present in an amount of 0.1 to 5% by weight.

The subject of the invention is, in addition, fibre-enriched powdered table sweeteners which, in addition to the branched maltodextrins and the said intense sweeteners, contain additional sugars or polyols.

These sugars or polyols are advantageously chosen from the group consisting of sucrose, dextrose, fructose, maltose, lactose, maltodextrins, dehydrated glucose syrups, sorbitol, xylitol, mannitol, maltitol, isomalt, lactitol and erythritol, taken alone or in combination.

According to an advantageous variant, the said fibre-enriched table sweeteners in accordance with the invention comprise from 3 to 50% by weight of the said branched maltodextrins, the balance by weight for 100% being a sugar or a polyol chosen from the group consisting of sucrose, fructose, dextrose, maltose, dehydrated glucose syrups, maltitol, xylitol, sorbitol, erythritol, isomalt, threitol and iditol, taken alone or in combination.

The fibre-enriched table sweeteners in accordance with the invention are prepared using a technique chosen from the techniques of co-spray-drying or of physical mixing of powders, taken alone or in combination, as will be exemplified below.

According to another variant of the present invention, the said table sweeteners may be formulated in liquid form, at a dry matter content of about 50%. These liquid table sweeteners then advantageously comprise 10 to 30% by weight of the said branched maltodextrins, hydrogenated or otherwise, and 20 to 40% by weight of at least one polyol chosen from the group consisting of maltitol, xylitol, erythritol, sorbitol, isomalt.

Very good results were obtained with a formulation comprising 20% by weight of hydrogenated branched maltodextrins, 15% by weight of erythritol, and 15% by weight of maltitol or xylitol.

The invention will be understood more clearly on reading the examples which follow and the figures relating thereto.

### EXAMPLE 1

### Preparation of Table Sweeteners in Accordance with the Invention

Three table sweeteners in accordance with the invention are prepared using techniques of co-spray-drying and of physical mixing of powders. Their respective compositions are presented in the following Table I.

TABLE I

| | Table | Table | Table |
|---|---|---|---|
| | sweetener | sweetener | sweetener |
| | A | B | C |
| Branched maltodextrins | 97 | 17 | 6 |
| Erythritol | | | 93 |
| Sucrose | | 83 | |
| Aspartame | 3 | | 1 |

The values are expressed in % by weight.

The branched maltodextrins have between 15 and 35% of 1→6 glucoside linkages, a reducing sugar content of between 2 and 5%, a polymolecularity index of less than 5 and a number-average molecular mass Mn of between 2000 and 3000 g/mol. The following Table 2 presents their precise composition.

TABLE 2

| | |
|---|---|
| Reducing sugars | 2.3 |
| Mn (g/mol) | 2480 |
| Mw (g/mol) | 5160 |
| 1,2 linkage (%) | 10 |
| 1,3 linkage (%) | 12 |
| 1,4 linkage (%) | 49 |
| 1,6 linkage (%) | 29 |

The said maltodextrins have, in addition, an insoluble fibre level of 55% on a dry basis, determined according to the AOAC method (No. 985-29).

To prepare the table sweetener A, the mixture of maltodextrin and aspartame is spray-dried under the following conditions.

A mixture of maltodextrins and aspartame in the proportions indicated in Table I at 40% of dry matter is brought to the temperature of 50° C.

The mixture thus preheated supplies a turbine FU11DA720 type NIRO spray-drier under the reference P208. The air temperature at the inlet of the spray-drier is set at a value of 200 to 210° C. and the air temperature at the outlet is 90° C.

To prepare the table sweetener B, the two constituents in powdered form are dry-mixed in a LÖDIGE type mixer by a technique which is moreover known to a person skilled in the art.

The packaging is carried out in 6 g bags, with no problem of phase separation being observed.

To prepare the table sweetener C, powders are also dry-mixed in a LÖDIGE type mixer, and the packaging is carried out in individual doses.

### EXAMPLE 2

### Study of the Stability, Under Acidic Conditions, of the Branched Maltodextrins Used as Bulking Agents

To assess the stability of the branched maltodextrins under acidic conditions, solutions are prepared at various pH values, containing either fructooligosaccharides (ACTILIGHT 950P or RAFTILOSE P35) as a control for the state of the art, or branched maltodextrins in accordance with the invention.

The variation in the molecular masses of these oligosaccharides in solution is measured during storage by steric exclusion followed by differential refractometric detection.

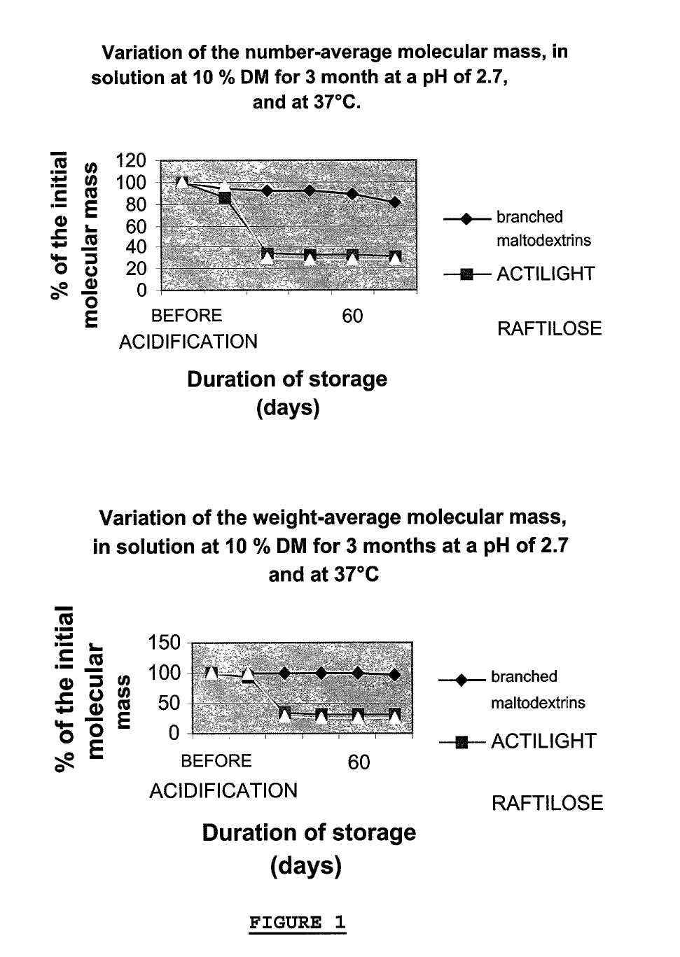

The results are illustrated in FIG. 1 (stability under acidic conditions).

In the case of the branched maltodextrins, a very slight effect of the acidification of the solutions is observed. There is therefore a slight hydrolysis at very acidic pH values (less than 3) which results in a variation in the molecular weight towards lower values. After two weeks of storage, the differences are not greater than those observed immediately after acidification. After 1 month of storage, only the values obtained for the very low pH values (less than 2.7) decreased compared with the two weeks ageing. The number-average molecular weight passes from 2800 daltons to 2400 daltons for solutions at pH 2.

In the case of the fructooligosaccharides, after two weeks of storage at pH 2, the molecular weight is reduced to 30% of its initial value. After 1 month, the solutions at pH 2 and 2.7 contain very highly degraded ACTILIGHT.

Conclusion: the branched maltodextrins are well suited to acidic pH conditions.

### EXAMPLE 3

### Characteristics of the Table Sweeteners in Accordance with the Invention

The tables below present the technological advantages conferred by the branched maltodextrin component as bulking agent for the table sweeteners in accordance with the invention.

The table sweetener A in accordance with the invention is compared with a CANDEREL type table sweetener, which also contains 3% by weight of aspartame, but 97% by weight of standard maltodextrin.

The table sweetener B in accordance with the invention is compared with an ACTISUCRE type table sweetener, which also contains 83% by weight of sucrose, but 17% by weight of fructooligosaccharides.

As for the table sweetener C in accordance with the invention, it is compared with an ELISLIM type table sweetener, which contains 99% by weight of erythritol and 1% by weight of aspartame.

The determination of the calorific value is carried out by calculation as indicated above. The determination of the insoluble fibre content of the bulking agent is carried out according to the AOAC method (No. 985-29). The stability in acidic medium is determined according to the protocol described in Example 2.

The following tables III, IV and V present the results obtained by comparing the table sweetener A with the CANDEREL type table sweetener, the table sweetener B with the ACTISUCRE type table sweetener and the table sweetener C with the ELISLIM type table sweetener, respectively.

Table III

| | CANDEREL type | Table |
|---|---|---|
| | table sweetener | sweetener A |
| Calorific value (Kcal/g) | 4 | 2.06 |
| Fibre content of the | <2 | 55 |
| bulking agent (%) | | |
| Stability under acidic | + | +++ |
| conditions | | |

TABLE IV

| | ACTISUCRE type | Table |
|---|---|---|
| | table sweetener | sweetener B |
| Calorific value (Kcal/g) | 3.66 | 3.66 |
| Fibre content of the | 2 | 55 |
| bulking agent (%) | | |
| Stability under acidic | + | +++ |
| conditions | | |

TABLE V

| | ELISLIM type | Table |
|---|---|---|
| | table sweetener | sweetener C |
| Calorific value (Kcal/g) | <1 | <1 |
| Fibre content of the | <1 | 55 |
| bulking agent (%) | | |
| Stability under acidic | + | +++ |
| conditions | | |

By virtue of their branched maltodextrin component as bulking agent, the table sweeteners in accordance with the invention have remarkable properties by virtue of their very high indigestible fibre content and their excellent stability under acidic conditions.

1. Fibre-enriched table sweeteners, which comprise from 3 to 99% by weight of branched maltodextrins having between 15 and 35% of 1→6 glucoside linkages, a reducing sugar content of less than 20%, a polymolecularity index of less than 5, and a number-average molecular mass Mn at most equal to 4500 g/mol, and in that they are stable under acidic conditions.

2. The table sweeteners of claim 1, wherein said branched maltodextrins have a reducing sugar content of between 2 and 5%, and a number-average molecular mass Mn of between 2000 and 3000 g/mol.

3. The table sweeteners of claim 1, wherein all or some of the said branched maltodextrins are hydrogenated.

4. The table sweeteners of claim 1, which comprise, in addition, an intense sweetener selected from the group consisting of aspartame, acesulfame K, saccharin, cyclamate, stevioside, sucralose, alone or as a mixture.

5. The table sweeteners of claim 4, wherein said intense sweetener is present in an amount of 0.1 to 5% by weight.

6. The table sweeteners of claim 1, which also comprise a sugar or a polyol selected from the group consisting of sucrose, dextrose, fructose, maltose, lactose, maltodextrins, dehydrated glucose syrups, sorbitol, xylitol, mannitol, maltitol, isomalt and erythritol, taken alone or in combination.

7. The table sweeteners of claim 1, which comprise from 3 to 50% by weight of the said branched maltodextrins, the balance by weight for 100% being a sugar or a polyol selected from the group consisting of sucrose, fructose, dextrose, maltose, dehydrated glucose syrups, maltitol, xylitol, sorbitol, erythritol, isomalt, threitol and iditol, taken alone or in combination.

8. Process for preparing table sweeteners according to claim 1, wherein a technique is used which is selected from the techniques of co-spray-drying or of physical mixing of powders, taken alone or in combination is used to prepare a table sweetener comprising from 3 to 99% by weight of branched maltodextrins having between 15 and 35% of 1→6 glucoside linkages, a reducing sugar content of less than 20%, a polymolecularity index of less than 5, and a number-average molecular mass Mn at most equal to 4500 g/mol.

9. The table sweetener of claim 1, which is provided in liquid form and which comprises 10 to 30% by weight of the said branched maltodextrins, hydrogenated or otherwise, and 20 to 40% by weight of at least one polyol selected from the group consisting of maltitol, xylitol, erythritol, sorbitol, isomalt.
